(19) United States
(12) Patent Application Publication
(10) Pub. No.: US 2019/0075445 A1
(43) Pub. Date: Mar. 7, 2019

(54) Emergency Call Radio System

(71) Applicant: Ramin Lavae Mokhtari, Potsdam (DE)

(72) Inventor: Ramin Lavae Mokhtari, Potsdam (DE)

(73) Assignee: Ice Gateway GmbH, Berlin (DE)

(21) Appl. No.: 16/182,297

(22) Filed: Nov. 6, 2018

Related U.S. Application Data
(63) Continuation of application No. PCT/EP2017/060701, filed on May 4, 2017.

(30) Foreign Application Priority Data
May 6, 2016 (DE) 10 2016 108 397.6

(51) Int. Cl. H04W 4/90; H04W 4/029; H04W 4/80; H04W 52/02

(52) U.S. Cl. CPC H04W 4/90; H04W 52/0254; H04W 4/80; H04W 4/029

(57) ABSTRACT

A transmitting device for an emergency call radio system is disclosed. The transmitting device includes an energy storage unit. The energy storage unit is configured to provide power for operation of the transmitting device. The transmitting device also includes a transmitter that is configured to transmit an emergency call radio signal if the transmitting device is activated. Still further, the transmitting device includes an actuation means. The actuation means is configured to activate the transmitting device or cause activation of the transmitting device if the actuation means is actuated.

### CROSS-REFERENCE TO RELATED PATENT APPLICATIONS

This application is a continuation of PCT/EP2017/060701, filed May 4, 2017, which claims priority to German Application No. 10 2016 108 397.6, filed May 6, 2016, the entire teachings and disclosure of which are incorporated herein by reference thereto.

### FIELD

Exemplary embodiments of the invention relate to a transmitting device for an emergency call radio system, a fixed device for an emergency call radio system, such an emergency call radio system, a use of a transmitting device for an emergency call radio system and a use of a fixed device for an emergency call radio system.

### BACKGROUND

Emergency call devices are known in the prior art which are equipped with means for position determination (for example a GPS module) and at the touch of a button to communicate an emergency call containing the last determined position of the emergency call device to an emergency call centre. However, a disadvantage of these known emergency call devices is that, with these emergency call devices, position determination is not possible or is inaccurate within buildings and below ground. In order to be able to communicate an emergency call with the most current possible position of the emergency call device to the emergency call centre at the touch of a button, the position of the emergency call device must also be permanently determined. Accordingly, at least the means for determining the position of these emergency call devices are permanently activated. This results in a high energy consumption and a high power requirement, even if the emergency call function is not activated, so that the operating life of the emergency call device is short. The energy storage unit of such emergency call devices needs to be charged frequently, because these devices need to be kept small and light. Charging can be necessary once or even several times daily, which the user always needs to bear in mind.

Other similar problems can arise in the case of solutions in which use is made of a smartphone because, for example, means for position determination of the smartphone are thereby used which also need to be permanently activated. Furthermore, additional problems can hereby arise, since the smartphone is managed by the user, who needs to ensure the functionality of the smartphone and its interaction with other components of the emergency call system (for example sufficient call time and data credit, updating of the operation system and compatibility, etc.).

### SUMMARY OF SOME EXEMPLARY EMBODIMENTS OF THE INVENTION

The present invention thus has the object, inter alia, of overcoming these problems.

According to a first aspect of the invention, a transmitting device for an emergency call radio system is disclosed, the transmitting device comprising:
an energy storage unit, wherein the energy storage unit is configured to provide power for operation of the transmitting device, and
a transmitter, wherein the transmitter is configured to transmit an emergency call radio signal if the transmitting device is activated, and
an actuation means, wherein the actuation means is configured to activate the transmitting device or cause activation of the transmitting device if the actuation means is actuated.

According to the first aspect of the invention, in addition a fixed device for an emergency call radio system is disclosed, the fixed device comprising:
a receiver, wherein the receiver is configured to receive an emergency call radio signal transmitted by a transmitting device of the emergency call radio system if the receiving device is located within the range of the transmitter of the transmitting device, and wherein the receiving device and/or means of the receiving device are configured to perform an action associated with the received emergency call radio signal if the receiver receives the emergency call radio signal.

According to the first aspect of the invention, in addition an emergency call radio system is disclosed, the emergency call radio system comprising:

at least one transmitting device according to the first aspect of the invention, and
at least one fixed device according to the first aspect of the invention.

According to the first aspect of the invention, in addition a use of a transmitting device according to the first aspect of the invention for the transmission of an emergency call radio signal (for example for the transmission of an emergency call radio signal in an emergency call radio system according to the first aspect of the invention) is disclosed.

According to the first aspect of the invention, in addition a use of a fixed device according to the first aspect of the invention for the communication of an emergency call signal (for example for the communication of an emergency call signal with position information on the fixed device in an emergency call radio system according to the first aspect of the invention) to an emergency call centre is disclosed.

The properties of the transmitting device, of the fixed device, of the emergency call radio system and the uses according to the invention according to the first aspect of the invention are described in the following—in some cases by way of example.

The fixed device should for example be understood to mean a permanently-installed device and/or a stationary device.

The transmitting device, in contrast, is preferably a mobile device. For example, the transmitting device is configured such that it is portable, for example it can be carried by a user. For example, the transmitting device is a small device with external dimensions of less than 10 cm×10 cm×5 cm, preferably less than 10 cm×5 cm×2 cm and/or is lighter than 500 g, preferably lighter than 200 g. The transmitting device can be a smartphone or part of a smartphone. However, alternatively or additionally, the transmitting device can also be a fixed device.

The energy storage unit of the transmitting device is preferably configured to provide electrical power for operation of the transmitting device (for example for operation of the transmitter of the transmitting device). Examples of such an energy storage unit are a battery, a capacitor and/or an accumulator.

The actuation means for activation of the transmitting device is for example mechanically operable, for example through the application of a force to the actuation means. In some exemplary embodiments of the first aspect of the invention the actuation means is and/or comprises a button (for example a mechanical button or a touch-sensitive button), a switch (for example a mechanical switch or a touch-sensitive switch), a magnetic switch and/or a relay. In other exemplary embodiments of the first aspect of the invention, the actuation means can be and/or comprise a light barrier, a motion sensor and/or a glass breakage sensor.

The transmitter of the transmitting device comprises for example an antenna and/or an analogue circuit for the transmission of a radio signal (for example of the emergency call radio signal). For example, the transmitter comprises an antenna and/or an analogue circuit for the transmission and reception of a radio signal (for example of the emergency call radio signal). In some exemplary embodiments of the first aspect of the invention, the transmitter is for example part of a transceiver. However, it also possible that the transmitting device does not include a receiver and the transmitter is not part of a transceiver.

For example, the transmitter of the transmitting device is a radio interface or is part of a radio interface.

The transmitting device further comprises for example one or more control means which are configured to cause and/or control the transmission of the emergency call radio signal by the transmitter if the transmitting device is activated. The control means can be part of the transmitter; alternatively, the control means can be separate from the transmitter. An example of one or more control means comprises at least one processor or at least one processor and at least one memory, for example at least one processor and at least one memory with program instructions, wherein the at least one memory and the program instructions are configured, jointly with the at least one processor, to cause and/or control the transmission of the emergency call radio signal by the transmitter if the transmitting device is activated.

The activation of the transmitting device should for example be understood to mean that the transmitter is caused to transmit the emergency call radio signal. In other words, the transmitting device should be understood to be activated if the transmitter transmits the emergency call radio signal.

For example, the transmitting device (for example the transmitter, the actuation means and the control means of the transmitting device) are configured to transmit the emergency call radio signal if the actuation means is actuated. For example, the actuation means is configured to generate an actuation signal and/or to cause the generation of an actuation signal if the actuation means for activation of the transmitting device is actuated. For example, the control means of the transmitting device described above are configured to detect such an actuation signal and cause the transmission of the emergency call radio signal by the transmitter if such an actuation signal is detected.

The emergency call radio signal is for example a radio or beacon signal transmitted by the transmitter.

The receiver of the fixed device comprises for example an antenna (for example an embedded antenna) and/or an analogue circuit for reception of a radio signal (for example of the emergency call radio signal). In some exemplary embodiments of the first aspect of the invention, the receiver is for example part of a transceiver and comprises an antenna and/or an analogue circuit for the transmission and reception of a radio signal (for example of the emergency call radio signal).

An action associated with the received emergency call radio signal should for example be understood to mean an action which a fixed device performs if the emergency call radio signal is received (for example, the fixed device performs a predefined action if the emergency call radio signal is received). For example, the fixed device comprises one or more control means which are configured to cause and/or control the performance of the action by the fixed device and/or by means of the fixed device if the emergency call radio signal is received. An example of such control means are at least one processor or at least one processor and at least one memory, for example at least one processor and at least one memory with program instructions, wherein the at least one memory and the program instructions are configured, jointly with the at least one processor, to cause and/or control the performance of the action by the fixed device and/or by means of the fixed device if the emergency call radio signal is received.

Examples of such an action associated with the emergency call radio signal are for example the triggering and/or causing the triggering of an acoustic or optical alarm signal, the triggering and/or causing the triggering of a video recording and/or a video transmission (for example to an emergency call centre) and/or the communication and/or causing the communication of an emergency call (for example to an emergency call centre) and/or causing street lighting to become brighter and/or dimmer and/or influencing one or more traffic light circuits (for example in order to ensure a so-called isochronous stretch of road in that the route to the destination, for example a police station, a hospital, etc. is optimised depending on the traffic).

For example, the fixed device is a stationary installation with built-in intelligence, continuous power supply and all data on the local circumstances which can implement measures immediately depending on the signal type.

A possible advantage of the first aspect of the invention is, inter alia, that different actions can be triggered through the transmission of the emergency call radio signal by the transmitting device of the emergency call radio system, without these actions being performed or controlled by the transmitting device itself. Instead, these actions are performed and/or controlled by one or more fixed devices of the emergency call radio system which receive the emergency call radio signal transmitted by the transmitting device. This means that the functionality of the transmitting device can at least substantially be limited to the transmitter, in contrast to the emergency call devices known from the prior art, which have further functionalities, for example for position determination. This allows, on the one hand, a particularly simple design as well as simple operability of the transmitting device according to the invention and on the other hand the longest possible operating life (i.e. the longest possible period of operation without charging of the energy storage unit being necessary, for example the longest possible battery and/or accumulator life) of the transmitting device according to the invention. In particular, the invention thus makes possible a simple yet very reliable solution for the mass market, wherein the user only requires a small device (the transmitting device according to the first aspect of the invention) with a long operating life, as long as there is also a stationary digital infrastructure (with one or more fixed devices according to the first aspect of the invention) which is for example provided and maintained by a municipal authority or by a company (for example an airport operator, a car park operator, a transport company or an industrial company).

Further possible advantages of the first aspect of the invention are described in the following with reference to exemplary embodiments of the transmitting device and the fixed device according to the first aspect of the invention.

In exemplary embodiments of the first aspect of the invention, the power requirement of the transmitting device, as long as the transmitting device is not activated, is less than 10 mW, preferably less than 1 mW, particularly preferably less than 0.5 mW. Such a low power requirement can for example be achieved if power is provided for operation of the transmitter and/or the transmitting device, and/or the transmitter and/or the transmitting device are in a standby operating mode with a lower power requirement as long as the transmitting device is not activated.

In exemplary embodiments of the first aspect of the invention, the power requirement of the transmitting device if the transmitting device is activated is greater than the power requirement of the transmitting device if the transmitting device is not activated. For example, the power requirement of the transmitting device if the transmitter is activated is greater than or equal to 1 mW, preferably greater than or equal to 10 mW, particularly preferably greater than or equal to 50 mW.

In exemplary embodiments of the first aspect of the invention, the transmitting device can only be activated through an actuation of the actuation means.

In exemplary embodiments of the first aspect of the invention, the operation of the actuation means has the effect that power is provided for operation of the transmitter and/or the transmitting device (for example for a predetermined period of time and/or as long as the actuation means is actuated). In this exemplary embodiment, the transmitting device should for example be understood to be activated if the power for operation of the transmitting device and/or of the transmitter is provided.

For example, the actuation means for activation of the transmitting device is configured to interrupt the supply of power for operation of the transmitter of the transmitting device and/or to cause interruption of the supply of power for operation of the transmitter of the transmitting device as long as the actuation means is not actuated. For example, the actuation means is configured to cause the closing of a circuit supplying power for operation of the transmitter and/or the transmitting device (for example for a predetermined period of time and/or as long as the actuation means is actuated) if the actuation means is actuated. For example, the actuation means is arranged in such a circuit, for example as a button, switch, magnetic switch and/or relay.

For example, the transmitter is configured to transmit the emergency call radio signal as soon as power is provided for operation of the transmitter and/or the transmitting device. Alternatively or additionally, the control means of the transmitting device described above are, for example, configured to cause and/or control the transmission of the emergency call radio signal by the transmitter as soon as power is provided for the operation of the transmitter and/or the transmitting device.

In exemplary embodiments of the first aspect of the invention, the operation of the actuation means has the effect that the transmitting device and/or the transmitter switches from a standby operating mode into a normal operating mode. In this exemplary embodiment, the transmitting device should for example be understood to be activated if the transmitting device and/or the transmitter is in the normal operating mode.

The standby operating mode (for example, a sleep operating mode of a processor and/or a standby operating mode) should for example be understood to mean an operating mode in which the power requirement of the transmitter and/or the transmitting device is reduced in comparison with the normal operating mode. This is for example achieved in that the full functionality of the transmitter and/or the transmitting device is only activated in the normal operating mode, whereas the functionality of the transmitter and/or the transmitting device is limited and/or deactivated in the standby operating mode. For example, the functionality of the transmitter and/or the transmitting device in the standby operating mode is limited to monitoring whether a wake-up condition for switching from the standby operating mode into the normal operating mode is fulfilled. Such a wake-up condition for switching from the standby operating mode into the normal operating mode is for example the detection of an actuation signal.

As described above, the actuation means for the activation of the transmitting device is for example configured to generate an actuation signal and/or cause generation of an actuation signal if the actuation means for the activation the transmitting device is actuated. For example, the control means of the transmitting device described above are further configured to switch from a standby operating mode into a normal operating mode if such an actuation signal is detected.

In exemplary embodiments of the first aspect of the invention, the emergency call radio signal is a predefined emergency call radio signal. For example, the predefined emergency call radio signal contains predefined information which identify the emergency call radio signal within the emergency call radio system as an emergency call radio signal. The predefined emergency call radio signal also contains, for example, user and/or device information (for example a user ID and/or a user identifier and/or a device ID and/or a device identifier) in order, on the one hand, to prevent misuse and on the other hand to provide assistance with support. For example, the predefined emergency call radio signal does not contain any position information and/or other changeable information such as for example time information.

It is for example possible that the emergency call radio signal is a predefined emergency call radio signal according to a predefined protocol of the emergency call radio system. For example, all devices of the emergency call radio system support such a predefined protocol and signals according to such a predefined protocol.

For example, a representation of the predefined emergency call radio signal is stored in a memory of the transmitting device (for example in a memory of the control means of the transmitting device described above).

For example, the predefined emergency call radio signal is configured to cause a fixed device of the emergency call radio system to perform an action associated with the predefined emergency call radio signal if the fixed device receives the predefined emergency call radio signal.

For example, the emergency call radio signal is selectable from a group of predefined emergency call radio signals at least partially depending on a single actuation, a multiple actuation and/or a sustained actuation of the actuation means. A single actuation of the actuation means should for example be understood to mean a one-time actuation of the actuation means (for example pressing a button once), a multiple actuation of the actuation means should be understood to mean a two-time or multiple-time actuation of the actuation means (for example pressing a button twice or multiple times) and a sustained actuation of the actuation means should be understood to mean a continuous actuation of the actuation means (for example holding down a button) within a predetermined period of time (for example 1 s).

For example, the control means of the transmitting device described above are configured to select the emergency call radio signal from the group of predefined emergency call radio signals at least partially depending on a single actuation, a multiple actuation and/or a sustained actuation of the actuation means. For example, the actuation signal described above is different for each of these actuations, so that the control means can distinguish the different actuations for example depending on the actuation signal.

This is for example advantageous in order to predefine different emergency call radio signals for the emergency call radio system which are associated with different actions. Each of these emergency call radio signals is accordingly configured to cause a fixed device of the emergency call radio system to perform a different action associated with the respective signal if the fixed device receives the respective emergency call radio signal. As a result, different reactions can be caused through single, repeated and sustained operation of the actuation means.

One example of an action associated with a predefined emergency call radio signal is the communication and/or causing the communication of an emergency call signal with position information on the fixed device to an emergency call centre (for example through communication means of the fixed device). Further examples of an action associated with a predefined emergency call radio signal are for example the triggering and/or causing the triggering of an acoustic or optical alarm signal, the triggering and/or causing the triggering of a video recording and/or a video transmission (for example to an emergency call centre). In cases in which the fixed device cannot perform the action associated with a predefined emergency call radio signal, a standard action can for example be specified which the fixed device performs instead.

In exemplary embodiments of the first aspect of the invention, the transmitting device does not include means for position determination of the transmitting device. Instead, the predefined emergency call radio signal is for example configured to cause a fixed device of the emergency call radio system to communicate an emergency call signal with position information on the fixed device to an emergency call centre if the fixed device receives the predefined emergency call radio signal.

This is on the one hand advantageous, since otherwise power for operation of such means for position determination would need to be permanently provided by the transmitting device in order to make possible a rapid position determination if the transmitting device is activated, so that the operating life of the transmitting device would be reduced. On the other hand, position determination using such means for position determination (for example a GPS module) is not possible or is inaccurate within buildings and below ground (for example in a shopping centre, a multi-storey car park, an underground car park, a railway station or underground railway station).

In exemplary embodiments of the first aspect of the invention, the emergency call radio signal is a signal according to a communication standard for a local wireless network, for example a communication standard for a local wireless network with a transmission range less than or equal to 150 m, preferably less than or equal to 100 m, particularly preferably less than or equal to 40 m. In this way it can be ensured that only fixed devices which are located in the vicinity of the transmitting device receive the emergency call radio signal.

A communication standard for a local wireless network should in particular be understood to mean communication standards of the IEEE-802 family. Examples of communication standards for a local wireless network are Bluetooth (for example Bluetooth Version 2.1 and/or 4.0) and/or Wireless Local Area Network (WLAN) and/or Zigbee. The Bluetooth specifications are currently available on the internet at www.bluetooth.org. WLAN is specified for example in the standards of IEEE-802.11 family. The Zigbee specifications are currently available on the internet at www.zigbee.org.

For example, the emergency call radio signal is
a Bluetooth signal,
a Bluetooth Low-Energy signal (BLE signal),
a BLE signal transmitted on an advertising channel,
a WLAN signal, and/or
a Zigbee signal.

For example, the emergency call radio signal is at least partially encrypted, for example according to a predefined protocol of the emergency call radio system and/or a protocol which is supported by the transmitting device and/or the fixed device.

This can also be divided into several stages in which for example the “transmission” is realised through sustained holding-down or repeated pressing.

In exemplary embodiments of the first aspect of the invention, the fixed device comprises one or more communication means, wherein the communication means are configured to communicate an emergency call signal from the fixed device to an emergency call centre if an emergency call radio signal transmitted from a transmitting device is received (for example if the communication of the emergency call signal from the fixed device to the emergency call centre is the action associated with the received emergency call radio signal).

The emergency call signal communicated by the fixed device to the emergency call centre comprises for example predefined information which identifies the emergency call signal as an emergency call signal.

For example, the emergency call signal communicated by the fixed device to the emergency call centre comprises position information on the fixed device.

For example, the emergency call signal is and/or represents a speech message and/or a text message, for example a speech message and/or a text message with such position information.

A representation of the emergency call signal and/or the position information on the fixed device can be stored in a memory of the fixed device (for example in a memory of the control means of the fixed device described above).

The communication means of the fixed device are for example configured to communicate with an emergency call centre via a communication link and transmit and/or receive information (for example position information). The communication link is for example wired or wireless or comprises at least one wired communication link and at least one wireless communication link. For example, the communication means of the fixed device comprise a wireless and/or a wired communication interface, for example a communication interface according to a wireless and/or wired communication standard.

An example of a communication interface is a radio interface, a network interface and/or a telephone interface.

Examples of a wireless communication standard are mobile communication standards such as Global System for Mobile Communications (GSM) and/or Universal Mobile Telecommunications System (UMTS) and/or Long Term Evolution (LTE). GMS, UMTS and LTE specifications are supported and developed by the 3rd Generation Partnership Project (3GPP) and are currently available on the internet at www.3gpp.com. Examples of a wired communication standard are for example Ethernet or Digital Subscriber Line (DSL). Ethernet is for example specified in the standards of the IEEE 802.3 family. DSL specifications are for example the standards of the ITU-T G.991 family and the ITU-T G.992 family.

In exemplary embodiments of the first aspect of the invention, the fixed device is installed in a public space and/or outdoors.

In exemplary embodiments of the first aspect of the invention, the fixed device is a network router and/or a gateway (for example an ICE gateway of the company ICE Gateway GmbH) and/or a wireless network access point. This is for example advantageous in order to be able to make use, at least partially, or an existing infrastructure for the emergency call radio system.

The fixed device is for example part of a streetlamp and/or a traffic lights system and/or is mounted and/or can be mounted on a streetlamp and/or a traffic lights system. However, the invention is not limited to this.

For example, the fixed device is part of a group of several fixed devices, wherein each of the fixed devices of the group of several fixed devices is located at a distance of less than 150 m, preferably less than 100 m, particularly preferably less than 40 m from at least one other of the fixed devices of the group of several fixed devices. This is for example advantageous in order to guarantee a good coverage of a particular location (for example of a shopping centre, a multi-storey car park, an underground car park, a railway station or underground railway station) by the group of several fixed devices.

The emergency call radio system comprises for example one or more such groups of fixed devices. For example, such a group of fixed devices is installed at each underground railway station of a transport company and/or at the airport of an airport operator, at a car park of a car park operator and/or on the works premises of an industrial company and/or at each railway station in a city.

According to a second aspect of the invention, a further transmitting device is disclosed, the further transmitting device comprising:

an energy storage unit, wherein the energy storage unit is configured to provide power for operation of the transmitting device, and
a transmitter, wherein the transmitter is configured to transmit a radio signal if the transmitting device is activated, and
an actuation means, wherein the actuation means is configured to activate the transmitting device or cause activation of the transmitting device if the actuation means is actuated.

According to the second aspect of the invention, in addition a further fixed device is disclosed, the further fixed device comprising:
a receiver, wherein the receiver is configured to receive a radio signal transmitted by a transmitting device if the fixed device is located within the range of the transmitter of the transmitting device, and wherein the fixed device and/or means of the fixed device are configured to perform an action associated with the received radio signal if the receiver receives the radio signal.

According to the second aspect of the invention, a radio system is disclosed, the radio system comprising:

at least one transmitting device according to the second aspect of the invention, and
at least one fixed device according to the second aspect of the invention.

According to the second aspect of the invention, in addition a use of a transmitting device according to the second aspect of the invention for the transmission of a radio signal (for example for the transmission of a radio signal within the radio system according to the second aspect of the invention) is disclosed.

The second aspect of the invention thus differs from the first aspect of the invention substantially in that any type of radio signal is transmitted by the transmitter of the transmitting device and received by the receiver of the fixed device. The second aspect is thus not limited to the transmission and reception of an emergency call radio signal. Otherwise, the disclosure relating to the first aspect of the invention is also intended to apply to the second aspect of the invention.

Further advantageous exemplary embodiments of the invention are explained in the following detailed description of a number of exemplary embodiments of the first aspect of the invention, in particular in combination with the figures. However, the figures enclosed with the application are only intended to be used for illustration purposes and not to define the scope of protection of the invention. The enclosed drawings are not necessarily true to scale and are simply intended to reflect in exemplary form the general concept of the present invention. In particular, features which are contained in the figures, should in no way be considered as a necessary element of the present invention.

### BRIEF DESCRIPTION OF THE DRAWINGS

In the drawings:

FIGS. 1a, b show block diagrams of exemplary embodiments of a transmitting device according to the first aspect of the invention;

FIG. 2 shows a block diagram of an exemplary embodiment of a fixed device according to the first aspect of the invention; and

FIG. 3 shows a block diagram of an exemplary embodiment of an emergency call radio system according to the first aspect of the invention.

### DETAILED DESCRIPTION

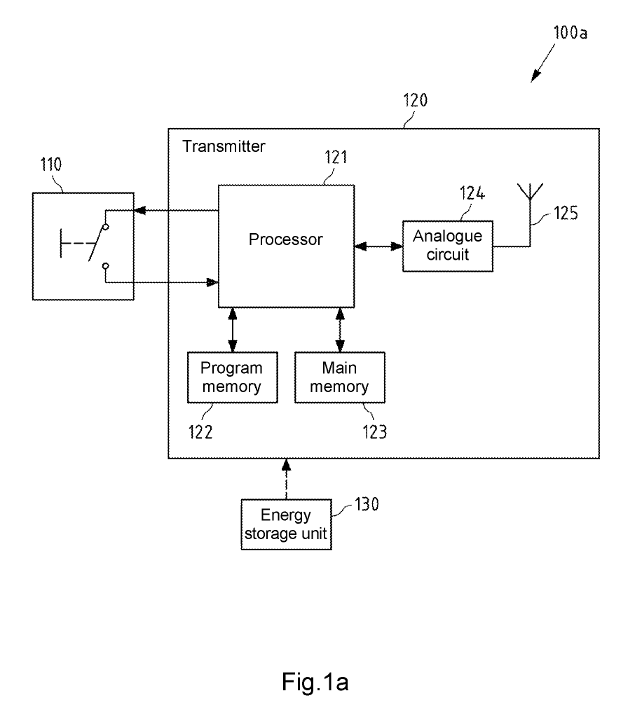

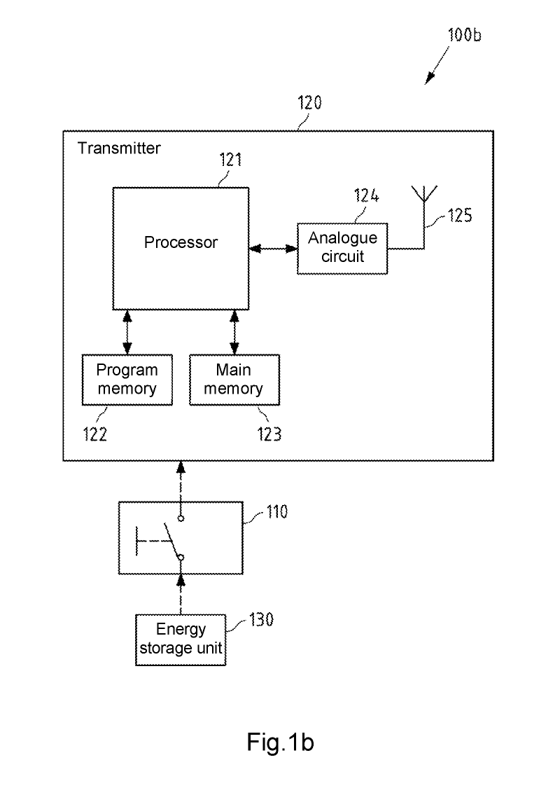

FIG. 1a is a block diagram of an exemplary embodiment of a transmitting device 100a according to the first aspect of the invention.

The transmitting device 100a comprises an actuation means 110, a transmitter 120 and an energy storage unit 130.

The transmitter 120 comprises a processor 121, a program memory 122, a main memory 123, an analogue circuit 124 and an antenna 125. In the following it is assumed by way of example that the transmitter 120 is a Bluetooth transmitter. However, the invention is not limited to this. In some embodiments, the Bluetooth transmitter is part of a Bluetooth transceiver.

The processor 121 is in particular designed in the form of a microcontroller or microprocessor. For example, the processor 121 is a Bluetooth baseband processor or comprises such a Bluetooth baseband processor.

The processor 121 executes program instructions which are stored in the program memory 122, and for example stores interim results or similar in the main memory 123. For example, the program memory 122 is a non-volatile memory such as a Flash memory, a magnetic storage device, a persistent read-only memory such as a ROM memory, an electronically erasable and programmable ROM memory (EEPROM) and/or an optical memory. The main memory 123 is for example a volatile or non-volatile memory, in particular a memory with random access (RAM) such as a static RAM memory (SRAM), a dynamic RAM memory (DRAM), a ferroelectric RAM memory (FeRAM) and/or a magnetic RAM memory (MRAM).

Preferably, the program memory 122 and main memory 123 are arranged together with the processor 121 in a module.

The processor 121 controls the Bluetooth transmitter 120. For example, program instructions are stored in the program memory 122 which, if it executes the program instructions, causes the processor 121 to control the transmission of a Bluetooth signal by the Bluetooth transmitter 120. For example, if it executes the program instructions, the program instructions cause the processor 121 to control the generation of a Bluetooth signal to be radiated by the antenna 125 through the analogue circuit 124. For example, the analogue circuit 124 is configured to generate a Bluetooth signal to be radiated by the antenna 125 if it is actuated accordingly by the processor 121. For this purpose, the analogue circuit 124 can comprise one or more filters, one or more mixers, one or more matching networks and/or one or more amplifiers.

The actuation means 110 serves to activate the transmitting device 100a. Activation of the transmitting device 100a should for example be understood to mean that the transmitter 120 is caused to transmit a predefined emergency call radio signal.

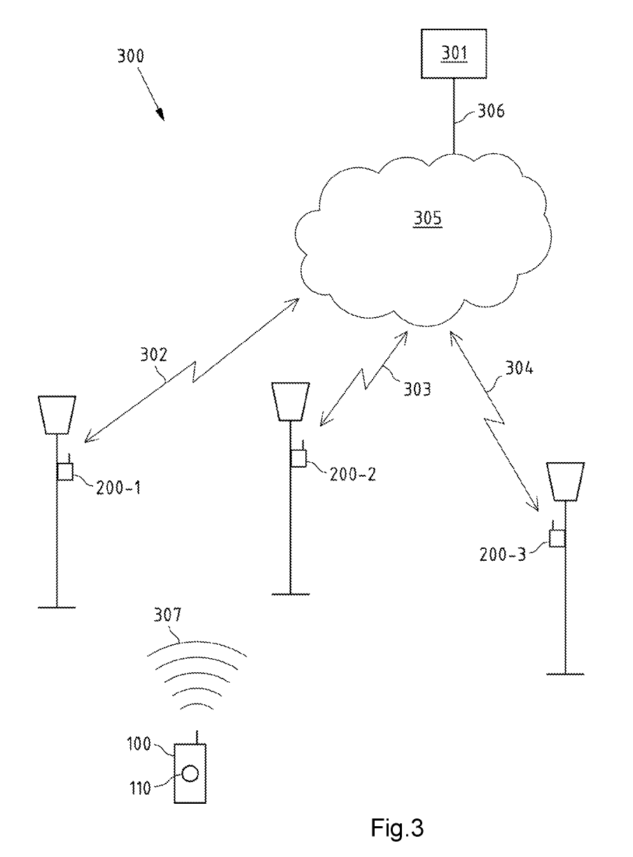

The predefined emergency call radio signal is a Bluetooth signal, for example a BLE signal. For example, the predefined emergency call radio signal is a predefined emergency call radio signal for the emergency call radio system represented in FIG. 3. For example, the predefined emergency call radio signal contains predefined information which identifies the emergency call radio signal as an emergency call radio signal in the emergency call radio system represented in FIG. 3. Furthermore, the predefined emergency call radio signal does not contain any position information and/or further changeable information such as for example time information, so that a representation of the predefined emergency call radio signal can be stored in the program memory 122. This is for example advantageous in order that the processor 121 does not need to determine the predefined emergency call radio signal and/or a representation of the predefined emergency call radio signal afresh each time.

The actuation means 110 is represented in FIG. 1a, by way of example, as a button and is connected with the processor 121 such that operating the actuation means 110 causes an actuation signal detectable by the processor to be generated.

In the exemplary embodiment represented in FIG. 1a, the processor 121 is configured to control the transmission of a predefined emergency call radio signal by the transmitter 120 if the processor 121 detects such an actuation signal. For this purpose, program instructions are for example stored in the program memory 122 which, if it executes the program instructions and detects such an actuation signal, cause the processor 121 to control the transmission of the predefined emergency call radio signal by the transmitter 120.

In a preferred embodiment, the processor 121 is configured to switch to a sleep operating mode if it does not detect any actuation signal and/or has not detected any actuation signal over a predetermined period, and to switch back into a normal operating mode if it detects an actuation signal. In the sleep operating mode, the processor 121 does not for example execute any program instructions but simply monitors whether an actuation signal can be detected. Accordingly, the functionality of the transmitter 120 is limited as long as the processor 121 is in the sleep operating mode. For example, the transmitter 120 is in a standby operating mode as long as the processor 121 is in the sleep operating mode. In the normal operating mode, on the other hand, the processor 121 executes program instructions, for example the program instructions described above which, if it executes the program instructions, causes the processor 121 to control the transmission of the predefined emergency call radio signal by the Bluetooth transmitter 120. The full functionality of the transmitter 120 is therefore only activated if the processor 121 is in the normal operating mode (for example the transmitter 120 is only also in the normal operating mode in this case). This preferred embodiment is for example advantageous in order to reduce the power requirement of the transmitting device 100a as long as the actuation means is not actuated, and thus in order to extend the operating life of the transmitting device 100a.

The energy storage unit 130 is configured to provide power for operation of the transmitting device 100a, in particular for operation of the transmitter 120. Examples of such an energy storage unit are a battery, a capacitor and/or an accumulator.

FIG. 1b is a block diagram of a further exemplary embodiment of a transmitting device 100b according to the first aspect of the invention.

Like the transmitting device 100a, the transmitting device 100b comprises an actuation means 110, a transmitter 120 and an energy storage unit 130.

As described above in detail with reference to FIG. 1a, the transmitter 120 comprises a processor 121, a program memory 122, a main memory 123, an analogue circuit 124 and an antenna 125. In the following it is again assumed, by way of example, that the transmitter 120 is a Bluetooth transmitter. However, the invention is not limited to this.

The actuation means 110 serves to activate the transmitting device 100b. Activation of the transmitting device 100b can thereby be understood to mean that the transmitter 120 is caused to transmit an emergency call radio signal.

The main difference between the transmitting devices 100a and 100b is that the actuation means 110 in the transmitting device 100b are connected with the transmitter 120 and the energy storage unit 130 such that operation of the actuation means 110 has the effect that power is provided for operation of the transmitter 120. In the exemplary embodiment illustrated in FIG. 1b, program instructions are for example stored in the program memory 122 which, if it executes the program instructions and power is provided for the operation of the transmitter 120, cause the processor 121 to control the transmission of the predefined emergency call radio signal by the Bluetooth transmitter 120.

The predefined emergency call radio signal is a Bluetooth signal, for example a BLE signal.

For example, the predefined emergency call radio signal, as described above with reference to FIG. 1a, is a predefined emergency call radio signal for the emergency call radio system illustrated in FIG. 3. For example, the predefined emergency call radio signal contains predefined information which identifies the emergency call radio signal as an emergency call radio signal in the emergency call radio system represented in FIG. 3. Furthermore, the predefined emergency call radio signal does not contain any position information and/or further changeable information such as for example time information, so that a representation of the predefined emergency call radio signal can be stored in the program memory 122. This is for example advantageous in order that the processor 121 does not need to determine the predefined emergency call radio signal and/or a representation of the predefined emergency call radio signal afresh each time.

The energy storage unit 130 is configured to supply power for operation of the transmitting device 100b, in particular for operation of the transmitter 120. Examples of such an energy storage unit are a battery, a capacitor and/or an accumulator.

The embodiment represented in FIG. 1b is for example advantageous in order only to provide power for operation of the transmitter if the actuation means is actuated, and thus guarantee the longest possible operating life of the transmitting device 100b.

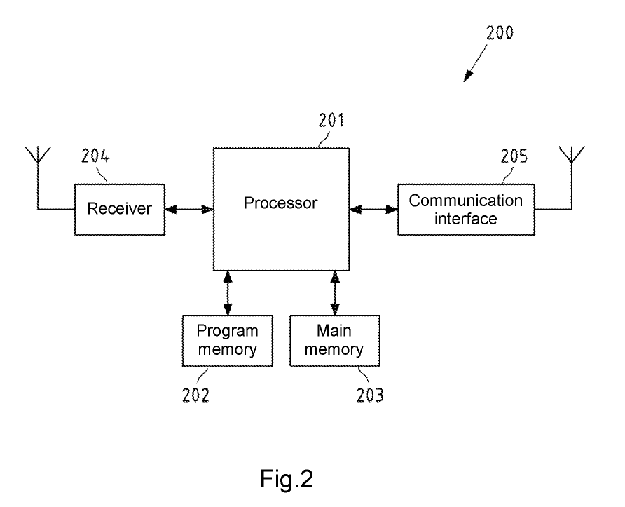

FIG. 2 shows a block diagram of an exemplary embodiment of a fixed device 200 according to the first aspect of the invention.

The processor 201 of the fixed device 200 is in particular designed in the form of a microcontroller or microprocessor. The processor 201 executes program instructions which are stored in the program memory 202, and for example stores interim results or similar in the main memory 203. For example, the program memory 202 is a non-volatile memory such as a Flash memory, a magnetic storage device, an EEPROM memory, a persistent memory such as a ROM memory and/or an optical memory. The main memory 203 is for example a volatile or non-volatile memory, in particular a memory with random access (RAM) such as a static RAM memory (SRAM), a dynamic RAM memory (DRAM), a ferroelectric RAM memory (FeRAM) and/or a magnetic RAM memory (MRAM).

Preferably, the program memory 202 and main memory 203 are arranged together with the processor 201 in a module.

The fixed device further comprises a receiver 204 and a wireless communication interface 205.

In the following it is assumed, by way of example, that the receiver 204 is a Bluetooth receiver. However, the invention is not limited to this. The Bluetooth receiver 204 is configured to receive a predefined emergency call radio signal transmitted by a transmitting device of the emergency call radio system (for example an emergency call radio signal transmitted by the transmitting devices 100a and/or 100b) if the receiving device is located within the range of the transmitter of the transmitting device. The predefined emergency call radio signal is a Bluetooth signal, for example a BLE signal. For example, the predefined emergency call radio signal is a predefined emergency call radio signal for the emergency call radio system represented in FIG. 3.

The Bluetooth receiver 204 comprises for example an analogue circuit (for example with one or more filters, one or more mixers, one or more matching networks and/or one or more amplifiers) and at least one antenna. Optionally, the Bluetooth receiver can also include its own processor (for example a Bluetooth baseband processor). In some embodiments, the Bluetooth receiver is part of a Bluetooth transceiver.

The processor 201 at least partially controls the Bluetooth receiver 204. For example, program instructions are stored in the program memory 202 which, if it executes the program instructions, cause the processor 201 at least partially to control the reception of a Bluetooth signal by the Bluetooth receiver 204. For example, if it receives a predefined emergency call radio signal transmitted by a transmitting device, the Bluetooth receiver 204 passes on corresponding information to the processor 201.

The wireless communication interface 205 is for example at least partially formed by a transceiver. In the following it is assumed, by way of example, that the communication interface 205 is a communication interface according to a mobile communication standard. However, the invention is not limited to this. As disclosed above, examples of a mobile communication standard include GSM, UMTS and/or LTE.

The processor 201 can at least partially control the wireless communication interface 205. For example, program instructions are stored in the program memory 202 which, if it executes the program instructions, cause the processor 201 to control the communication of an emergency call signal to an emergency call centre (for example the emergency call centre 301 in FIG. 3) through the wireless communication interface 205 if the Bluetooth receiver 204 receives a predefined emergency call radio signal transmitted by a transmitting device.

In a preferred embodiment, the emergency call signal contains position information on the fixed device. For example, the emergency call signal is and/or represents a speech message and/or a text message containing such position information. A representation of the emergency call signal and/or the position information on the fixed device can be stored in the program memory 202. This is for example advantageous in order to avoid the processor 201 needing to determine the emergency call signal and/or a representation of the emergency call signal and/or the position information afresh each time.

FIG. 3 shows a block diagram of an exemplary embodiment of an emergency call radio system 300 according to the first aspect of the invention.

The emergency call radio system 300 comprises a transmitting device 100 and fixed devices 200-1, 200-2 and 200-3. The transmitting device 100 corresponds to one of the transmitting devices 100a or 100b represented in FIGS. 1a and 1b. The fixed devices 200-1, 200-2 and 200-3 correspond to the fixed device 200 represented in FIG. 2.

Each of the fixed devices 200-1, 200-2 and 200-3 is for example arranged in a public space at a distance of less than 40 m from at least one of the other fixed devices 200-1, 200-2 and 200-3. This is for example advantageous in order to achieve the best possible coverage of the public space, since the typical range of BLE signals is approximately 40 m. In FIG. 3, the fixed devices 200-1, 200-2 and 200-3 are, by way of example, attached to streetlamps. This is for example advantageous because use can be made of an existing streetlamp infrastructure. Within cities and in car parks, streetlamps and/or lampposts are frequently positioned up to 30 m apart from one another and make it possible to attach the fixed devices at a particular height (for example above 3 m). This make it possible to guarantee good coverage. However, the invention is not limited to this and it is possible to install the fixed devices 200-1, 200-2 and 200-3 in other locations (for example in advertising displays, on traffic lights, on the walls of buildings, etc.).

The fixed devices 200-1, 200-2 and 200-3 are connected with the communications network 305 via one of the wireless communication links 302, 303 and 304.

The emergency call radio system 300 further comprises an optional emergency call centre 301, which is also connected with the communications network 305 via a communication link 306.

The fixed devices 200-1, 200-2 and 200-3 can thus communicate with the emergency call centre 301 via the wireless communication links 302, 303 and 304, the communications network 305 and the communication link 306.

The interaction of the different components of the emergency call radio system 300 is described in the following by way of example.

If a user of the transmitting device 100 in the public space finds themselves in an emergency situation, they can operate the actuation means 110 of the transmitting device 100 in order to cause the transmission of a predefined emergency call radio signal 307 by the transmitter 120 of the transmitting device 100.

Preferably, the emergency call radio signal 307 is transmitted by the transmitting device as a radio signal or as a beacon signal.

This predefined emergency call radio signal 307 is for example received by one or more of the fixed devices 200-1, 200-2 and 200-3 and causes the fixed devices 200-1, 200-2 and 200-3, if they receive the predefined emergency call radio signal 307, to communicate an emergency call signal to the emergency call centre 301.

A communication between the fixed devices 200-1, 200-2 and 200-3 and the transmitting device 100 only takes place, for example, through the predefined emergency call radio signal 307 from the transmitting device 100 to the fixed devices 200-1, 200-2 and 200-3, for example the fixed devices 200-1, 200-2 and 200-3 do not reply to the transmitting device 100.

As described above, in a preferred embodiment the emergency call signal contains position information on the respective fixed device, so that the emergency call centre can narrow down the location of the emergency call to the area surrounding the respective fixed device (for example the reception range).

The exemplary embodiments of the present invention described in this specification should also be understood as being disclosed in all combinations with each other

Terms used in the claims such as “comprise”, “have”, “contain”, “include” and the like do not exclude additional elements or steps. The wording “at least partially” includes both the case of “partially” and also the case of “fully”. The wording “and/or” should be understood as both the alternative and the combination being disclosed, i.e. “A and/or B” means “(A) or (B) or (A and B)”. A plurality of units, individuals or the like means multiple units, individuals or the like in the context of this specification. The use of the indefinite article does not exclude a plurality. An individual apparatus can perform the functions of a plurality of units or apparatuses mentioned in the claims. Reference numerals indicated in the claims should not be considered as limitations of the means and steps used.

1. A transmitting device for an emergency call radio system, the transmitting device comprising:
an energy storage unit, wherein the energy storage unit is configured to provide power for operation of the transmitting device, and
a transmitter, wherein the transmitter is configured to transmit an emergency call radio signal if the transmitting device is activated, and
an actuation means, wherein the actuation means is configured to activate the transmitting device or cause activation of the transmitting device if the actuation means is actuated.

2. The transmitting device according to claim 1, wherein the power requirement of the transmitting device, if the transmitting device is not activated, is less than 10 mW, preferably less than 1 mW.

3. The transmitting device according to claim 2, wherein the power requirement of the transmitting device, if the transmitting device is activated, is greater than the power requirement of the transmitting device if the transmitting device is not activated.

4. The transmitting device according to claim 1, wherein the actuation of the actuation means has the effect that power is supplied for operation of the transmitting device and/or of the transmitter, and wherein the transmitting device is activated if power for operation of the transmitting device and/or of the transmitter is supplied.

5. The transmitting device according to claim 1, wherein the actuation of the actuation means has the effect that the transmitting device and/or the transmitter switches from a standby operating mode into a normal operating mode, and wherein the transmitting device is activated if the transmitting device and/or the transmitter is in the normal operating mode.

6. The transmitting device according to claim 1, wherein the emergency call radio signal is a predefined signal which is configured to cause a fixed device of the emergency call radio system to perform an action associated with the predefined emergency call radio signal if the fixed device receives the emergency call radio signal.

7. The transmitting device according to claim 6, wherein the action associated with the emergency call radio signal is the communication and/or causing the communication of an emergency call signal with position information on the fixed device from the fixed device to an emergency call centre.

8. The transmitting device according to claim 6, wherein the emergency call radio signal is selectable from a group of predefined signals at least partially depending on a single actuation, a multiple actuation and/or a sustained actuation of the actuation means.

9. The transmitting device according to claim 1, wherein the emergency call radio signal is a signal according to a standard for a local wireless network, in particular a Bluetooth signal.

10. The transmitting device according to claim 1, wherein the actuation means comprises a button, a switch, a mechanical switch, a magnetic switch and/or a relay.

11. A fixed device for an emergency call radio system, the fixed device comprising:
a receiver, wherein the receiver is configured to receive an emergency call radio signal transmitted by a transmitting device of the emergency call radio system if the receiving device is located within the range of the transmitter of the transmitting device, and wherein the receiving device and/or means of the receiving device are configured to perform an action associated with the received emergency call radio signal if the receiver receives the emergency call radio signal.

12. The fixed device according to claim 11, wherein the fixed device further comprises:
one or more communication means, wherein the communication means are configured to communicate an emergency call signal with position information on the fixed device to an emergency call centre if an emergency call radio signal is transmitted by a transmitting device, wherein the communication of the emergency call signal with position information on the fixed device to the emergency call centre is the action associated with the received emergency call radio signal.

13. The fixed device according to claim 11, wherein the fixed device is part of a group of several fixed devices, and wherein each of the fixed devices of the group of several fixed devices is located at a distance of less than 150 m, preferably less than 100 m, particularly preferably less than 40 m from at least one other of the fixed devices of the group of several fixed devices.

14. An emergency call radio system, the emergency call radio system comprising:
at least one transmitting device according to claim 1, and
at least one fixed device for an emergency call radio system, the fixed device comprising:
a receiver, wherein the receiver is configured to receive an emergency call radio signal transmitted by the at least one transmitting device of the emergency call radio system if the receiving device is located within the range of the transmitter of the transmitting device, and wherein the receiving device and/or means of the receiving device are configured to perform an action associated with the received emergency call radio signal if the receiver receives the emergency call radio signal.

15. A method of transmitting an emergency call radio signal comprising the step of utilizing the transmitting device according to claim 1.
